(19) United States
(12) Patent Application Publication
(10) Pub. No.: US 2026/0170438 A1
(43) Pub. Date: Jun. 18, 2026

(54) INFORMATION PROCESSING APPARATUS

(71) Applicant: NEC Corporation, Tokyo (JP)

(72) Inventors: Yuya ENDO, Tokyo (JP); Hiromi SHIMIZU, Tokyo (JP); Natsumi KINUGAWA, Tokyo (JP)

(73) Assignee: NEC Corporation, Tokyo (JP)

(21) Appl. No.: 19/405,714

(22) Filed: Dec. 2, 2025

(30) Foreign Application Priority Data
Dec. 18, 2024 (JP) 2024-221552

(51) Int. Cl. G06Q 10/0637; G06F 40/166

(52) U.S. Cl. CPC G06Q 10/0637; G06F 40/166

(57) ABSTRACT

An information processing apparatus includes a genre information acquisition unit that acquires genre information indicating a genre to which a consideration subject belongs, a framework information acquisition unit that acquires framework information related to the consideration subject, a value information acquisition unit that acquires value information indicating a value desired to be incorporated into the consideration subject, and a concept information generation unit that generates concept information indicating a consideration result of the consideration subject according to the genre information, the framework information, and the value information.

### INCORPORATION OF BASIC APPLICATION

The present invention claims the benefit of the priority of Japanese Patent Application No. 2024-221552 filed on Dec. 18, 2024 in Japan, the contents of which are incorporated herein by reference in its entirety.

### TECHNICAL FIELD

The present invention relates to an information processing apparatus, an information processing method, and a recording medium.

### BACKGROUND ART

Techniques used in assisting business are known.

For example, JP 7591175 B2 describes an information processing system that supports creation of a document for evaluating business feasibility of a business operator. For example, the information processing system includes first acquisition means, second acquisition means, and first output means. According to JP 7591175 B2, the first acquisition means instructs a generative AI to output input information for an input item of the document for evaluating the business feasibility, for a designated business operator and acquires the output input information. The second acquisition means instructs the generative AI to output a question sentence to acquire insufficient information from the designated business operator, regarding the acquired input information and acquires the output question sentence. At this time, the second acquisition means instructs the generative AI to specify the insufficient information based on the input information for the input item output by the generative AI in the past. Then, the first output means outputs the acquired question sentence.

Patent Literature 1: Japanese Patent Publication No. JP 7591175 B2

### SUMMARY

When business is conducted, there is a case where it is desired to draft a concept for a consideration subject such as a new product or new content. However, it is difficult to cope with such drafting with the technology described in JP 7591175 B2. As a result, there has been a problem in that it may be difficult to support concept drafting regarding a consideration subject.

An object of the present disclosure is to provide an information processing apparatus, an information processing method, and a recording medium that can solve the above problems.

An information processing apparatus according to the present disclosure for achieving the object includes
a genre information acquisition unit that acquires genre information indicating a genre to which a consideration subject belongs,
a framework information acquisition unit that acquires framework information related to the consideration subject,
a value information acquisition unit that acquires value information indicating a value desired to be incorporated into the consideration subject, and
a concept information generation unit that generates concept information indicating a consideration result of the consideration subject according to the genre information, the framework information, and the value information.

An information processing method according to the present disclosure has a configuration in which
acquires genre information indicating a genre to which a consideration subject belongs,
acquires framework information related to the consideration subject,
acquires value information indicating a value desired to be incorporated into the consideration subject, and
generates concept information indicating a consideration result of the consideration subject according to the genre information, the framework information, and the value information.

A recording medium according to the present disclosure is a computer-readable recording medium recording a program for causing an information processing apparatus to achieve processing for
acquiring genre information indicating a genre to which a consideration subject belongs,
acquiring framework information related to the consideration subject,
acquiring value information indicating a value desired to be incorporated into the consideration subject, and
generating concept information indicating a consideration result of the consideration subject according to the genre information, the framework information, and the value information.

According to each configuration described above, it is possible to support concept drafting regarding a consideration subject.

### BRIEF DESCRIPTION OF THE DRAWINGS

FIG. 1 is a diagram illustrating a configuration of a generation system according to the present disclosure;

FIG. 2 is a block diagram illustrating a configuration example of a generation device;

FIG. 3 is a diagram for explaining a processing example of an environment information acquisition unit;

FIG. 4 is a diagram illustrating an example of business environment information;

FIG. 5 is a diagram for explaining a processing example of a strategy information acquisition unit;

FIG. 6 is a diagram illustrating an example of business strategy information;

FIG. 7 is a diagram illustrating an example when value information is acquired;

FIG. 8 is a diagram illustrating an example when the value information is acquired;

FIG. 9 is a diagram for explaining a processing example of a concept information generation unit;

FIG. 10 is a diagram illustrating an example of concept information;

FIG. 11 is a flowchart illustrating an operation example of the generation device;

FIG. 12 is a diagram illustrating a configuration example of a generation system according to a second example embodiment of the present disclosure;

FIG. 13 is a block diagram illustrating a hardware configuration example of an information processing apparatus according to a third example embodiment of the present disclosure;

FIG. 14 is a block diagram illustrating a configuration example of the information processing apparatus; and

FIG. 15 is a flowchart illustrating an operation example of the information processing apparatus.

### EXAMPLE EMBODIMENT

### First Example Embodiment

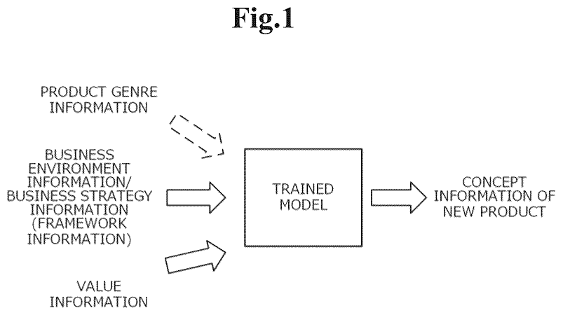

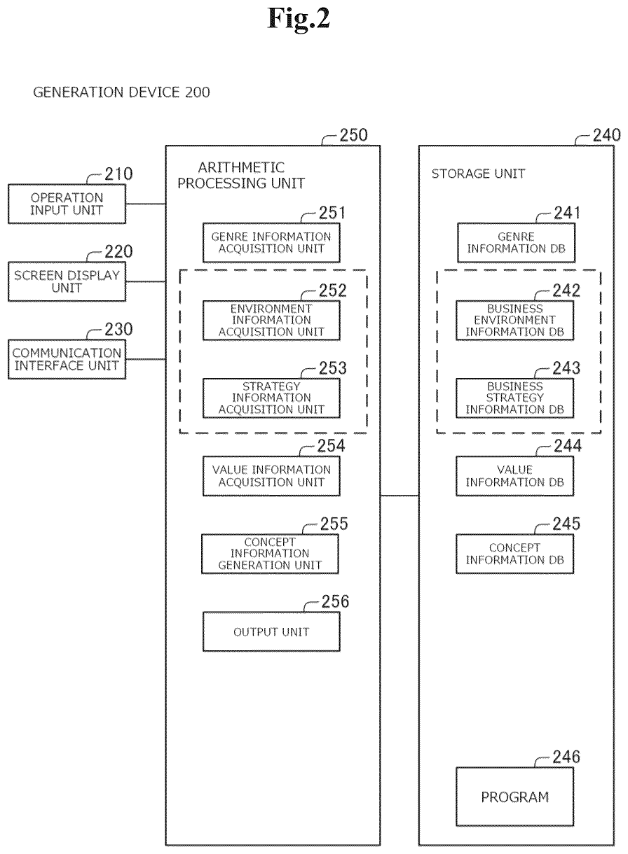

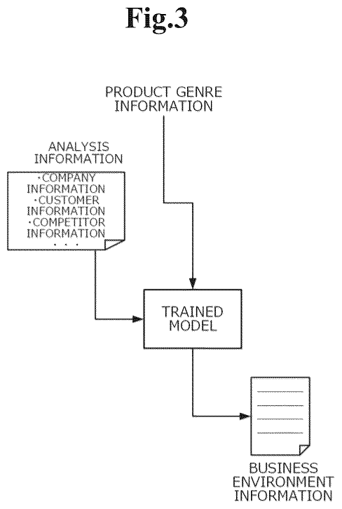

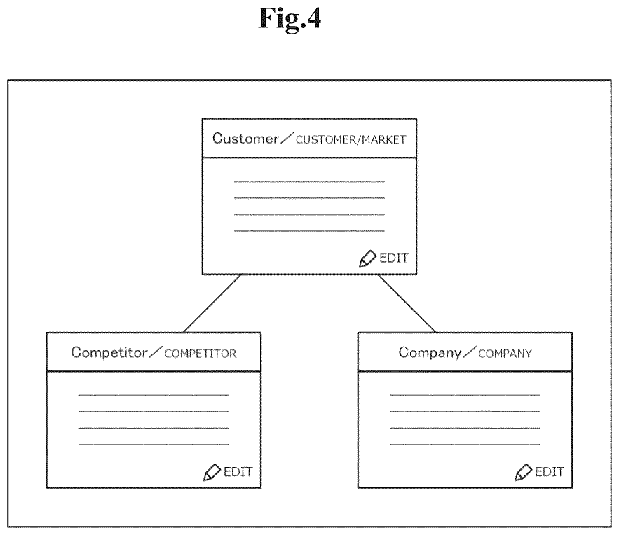

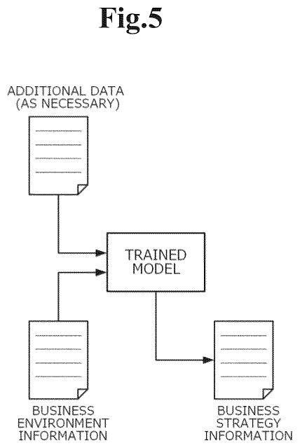

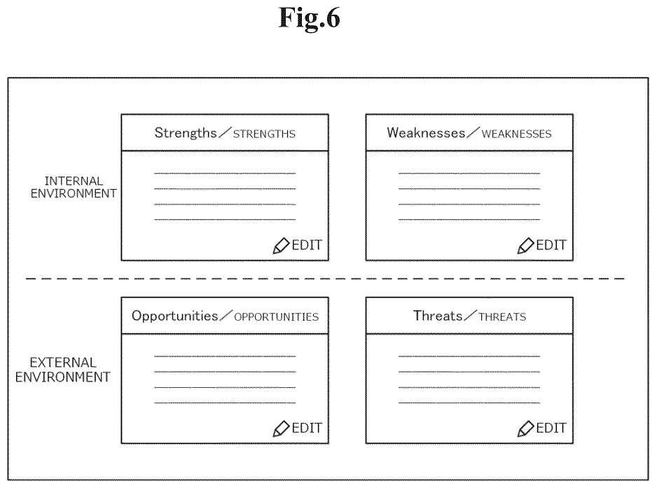

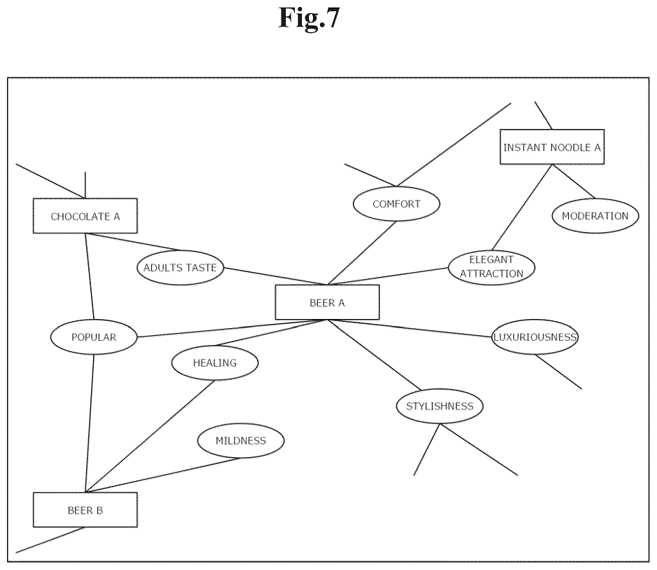

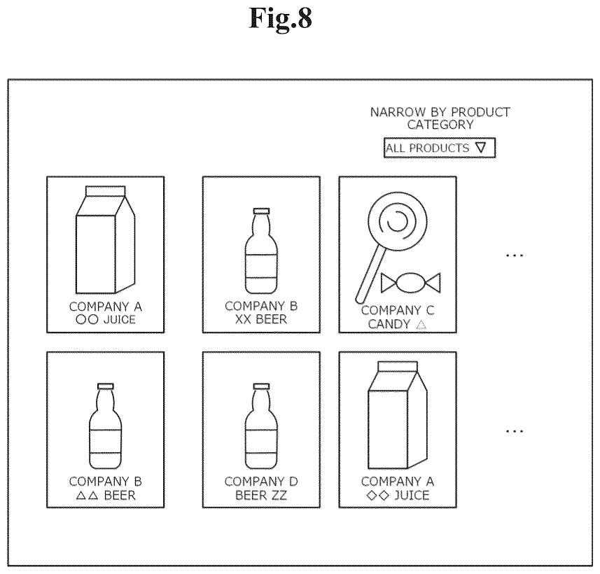

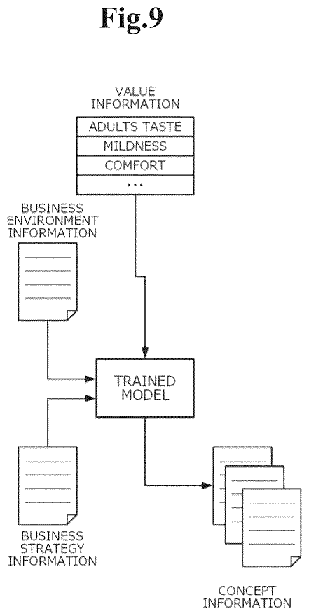

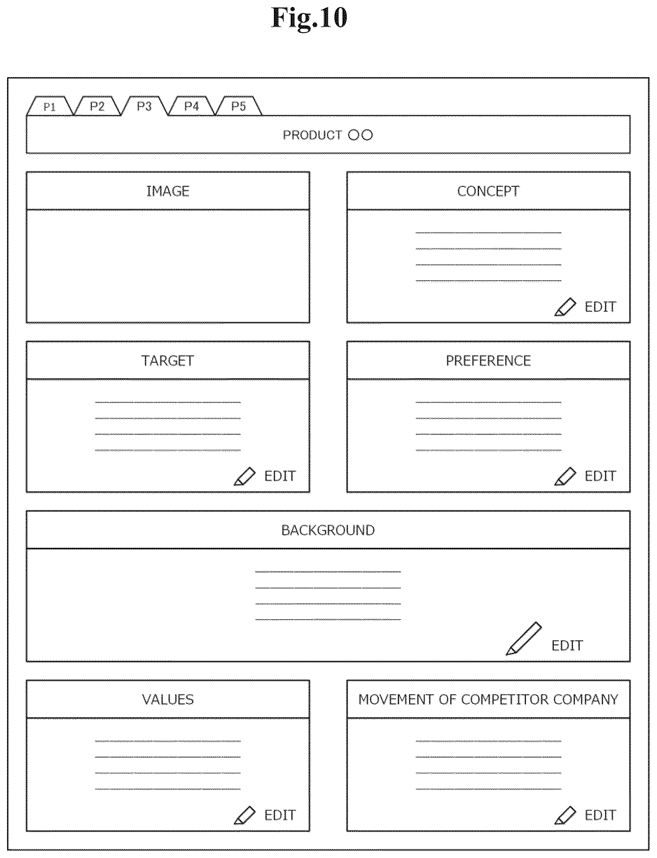

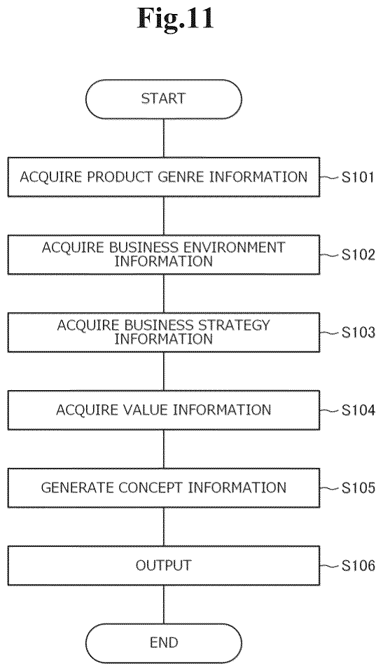

A configuration example of a generation system 100 according to the present disclosure will be described with reference to FIGS. 1 to 11. FIG. 1 is a diagram illustrating a configuration of the generation system 100. FIG. 2 is a block diagram illustrating a configuration example of a generation device 200. FIG. 3 is a diagram for explaining a processing example of an environment information acquisition unit 252. FIG. 4 is a diagram illustrating an example of business environment information. FIG. 5 is a diagram for explaining a processing example of a strategy information acquisition unit 253. FIG. 6 is a diagram illustrating an example of business strategy information. FIGS. 7 and 8 are diagrams illustrating examples when value information is acquired. FIG. 9 is a diagram for explaining a processing example of a concept information generation unit 255. FIG. 10 is a diagram illustrating an example of concept information. FIG. 11 is a flowchart illustrating an operation example of the generation device 200. In the present disclosure, the drawings may be associated with one or more example embodiments.

In the present disclosure, the generation system 100 will be described that drafts a concept of a consideration subject such as a new product or new content based on acquired information. As described later, the generation system 100 acquires genre information indicating a genre to which the consideration subject belongs, framework information related to the consideration subject, and value information indicating values desired to be incorporated into the consideration subject. Then, the generation system 100 generates concept information indicating a consideration result of the consideration subject according to the genre information, the framework information, and the value information. For example, the generation system 100 generates the concept information including information indicating the concept of the new product or the like, by inputting the genre information, the framework information, and the value information into a trained model such as a Large Language Model (LLM). As described later, the genre information may be directly input into the trained model and may be input via the framework information by using the genre information at the time when the framework information is generated.

Hereinafter, a case where the consideration subject is a new product will be described as an example. For example, FIG. 1 illustrates an outline of the generation system 100 in a case where the consideration subject is the new product. Referring to FIG. 1, the generation system 100 acquires product genre information, the framework information such as business environment information or business strategy information, and the value information. Then, the generation system 100 generates the concept information by inputting each piece of the acquired information into the trained model. As described later, the consideration subject is not limited to the new product. For example, the consideration subject may be a new program or any other new content. The consideration subject may be any other subject.

In the present disclosure, the framework information may relate to the consideration subject. For example, in a case where the consideration subject is the new product, the framework information may be at least one of the business environment information, the business strategy information, and the like. Here, the business environment information is information indicating an environment or the like in which a company that develops the new product to be considered is placed. For example, the business environment information may be 3C information or the like that can be acquired as a result of 3C analysis that is a framework in which three environments including “Customer (customer)”, “Competitor (competitor)”, and “Company (company)” are set as analysis targets. The business environment information may be information other than the above. For example, the business environment information may be PEST information that can be acquired as a result of PEST analysis in which four external environments including “Politics (politics)”, “Economy (economy)”, “Society (society)”, and “Technology (technology)” are set as analysis targets. The business environment information may be information indicating an environment analyzed using any other framework. The business strategy information is information indicating a strategy of a company or used to draft a strategy. For example, the business strategy information may be SWOT information that can be acquired as a result of SWOT analysis that is a framework for performing analysis in four categories including “Strengths (strengths)”, “Weaknesses (weaknesses)”, “Opportunities (opportunities)”, and “Threats (threats)”. The business strategy information may be information other than the above. For example, the business strategy information may be 5 force information that can be acquired as a result of 5 force analysis or the like. The business strategy information may be information related to a strategy analyzed using any other framework.

In the present disclosure, the values indicate information indicating a feature of the consideration subject such as a product. For example, the value may be abstracted features of a product or the like. The value may include at least some of information indicating an image of a product, information indicating a subject associated with the product, information indicating an impression or emotion of a user received from the product, a related word related to the product, or the like, in addition to those described above.

Hereinafter, details of the generation system 100 will be described. FIG. 2 illustrates a main configuration example of the generation device 200 that is an information processing apparatus included in the generation system 100. The generation device 200 is an information processing apparatus that drafts a concept regarding a new product. Referring to FIG. 2, the generation device 200 includes an operation input unit 210, a screen display unit 220, a communication interface unit 230, a storage unit 240, and an arithmetic processing unit 250, as main components.

In FIG. 2, a case is illustrated where functions as the generation device 200 are achieved using the single information processing apparatus. However, at least some of the functions of the generation device 200 may be achieved using the plurality of information processing apparatuses, for example, achieved on a cloud. The generation device 200 does not need to include a part of the illustrated configuration such as the operation input unit 210 or the screen display unit 220 or may include a configuration other than the configuration described above.

The operation input unit 210 includes an operation input device such as a keyboard or a mouse. The operation input unit 210 detects an operation of a user who operates the generation device 200 and outputs the operation to the arithmetic processing unit 250.

The screen display unit 220 includes a screen display device such as a liquid crystal display or an organic electro-luminescence (EL). The screen display unit 220 can display various types of information stored in the storage unit 240 or the like on a screen, in response to an instruction from the arithmetic processing unit 250.

The communication interface unit 230 includes a data communication circuit or the like. The communication interface unit 230 performs data communication with an external device connected via a communication line.

The storage unit 240 is a storage device such as a hard disk or a memory. The storage unit 240 stores processing information necessary for various types of processing of the arithmetic processing unit 250 and a program 246. The program 246 is read and executed by the arithmetic processing unit 250 to achieve various processing units. The program 246 is read from an external device or a recording medium in advance via a data input/output function such as the communication interface unit 230 and is saved in the storage unit 240. Examples of main information stored in the storage unit 240 include a genre information database (DB) 241, a business environment information DB 242, a business strategy information DB 243, a value information DB 244, a concept information DB 245, or the like.

The genre information DB 241 includes the genre information indicating the genre to which the new product that is the consideration subject belongs. The genre information DB 241 can be updated, for example, by a genre information acquisition unit 251 acquiring the genre information such as the product genre information.

The business environment information DB 242 includes the business environment information such as the 3C information. In other words, the business environment information DB 242 includes the framework information. The business environment information DB 242 can be updated, for example, by the environment information acquisition unit 252 that functions as one of framework information acquisition units acquiring the business environment information such as the 3C information.

The business strategy information DB 243 includes the business strategy information such as the SWOT information. In other words, the business strategy information DB 243 includes the framework information. The business strategy information DB 243 can be updated, for example, by the strategy information acquisition unit 253 that functions as one of the framework information acquisition units acquiring the business strategy information such as the SWOT information.

The value information DB 244 includes the value information. The value information DB 244 can be updated, for example, by a value information acquisition unit 254 acquiring the value information.

The concept information DB 245 includes the concept information. The concept information DB 245 can be updated, for example, by the concept information generation unit 255 generating the concept information.

The arithmetic processing unit 250 includes an arithmetic device such as a Central Processing Unit (CPU) and peripheral circuits thereof. The arithmetic processing unit 250 causes the hardware to cooperate with the program 246 and achieves various processing units by reading and executing the program 246 from the storage unit 240. Examples of the main processing unit achieved by the arithmetic processing unit 250 include the genre information acquisition unit 251, the environment information acquisition unit 252, the strategy information acquisition unit 253, the value information acquisition unit 254, the concept information generation unit 255, an output unit 256, or the like.

Instead of the CPU described above, the arithmetic processing unit 250 may include a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, a combination of these, or the like.

The genre information acquisition unit 251 acquires information indicating the genre to which the consideration subject belongs, such as the product genre information. For example, the genre information acquisition unit 251 acquires the product genre information, for example, by receiving an operation on the operation input unit 210 or receiving information from an external device via the communication interface unit 230. The genre information acquisition unit 251 stores the acquired product genre information in the genre information DB 241.

As an example, the genre information acquisition unit 251 acquires information indicating a type of the consideration subject such as “kitchenware”, “beverages”, or “daily necessities”, as the product genre information. The genre information acquisition unit 251 may acquire the product genre information in which the types are further limited, such as “daily necessities of action heroes”, “nice kitchenware”, “coffee”, or “beer”. The genre information acquisition unit 251 may acquire any more comprehensive product genre information.

The environment information acquisition unit 252 functions as one of the framework information acquisition units. The environment information acquisition unit 252 acquires the business environment information such as the 3C information. The environment information acquisition unit 252 stores the acquired business environment information in the business environment information DB 242.

For example, the environment information acquisition unit 252 can acquire the business environment information such as the 3C information, for example, by receiving the operation on the operation input unit 210 or receiving the information from the external device via the communication interface unit 230.

The environment information acquisition unit 252 may acquire the business environment information such as the 3C information, by inputting analysis information (hereinafter, referred to as analysis information) into the trained model. FIG. 3 illustrates a more detailed processing example when the environment information acquisition unit 252 acquires the business environment information such as the 3C information using the analysis information. Referring to FIG. 3, the environment information acquisition unit 252 acquires the analysis information, for example, by receiving the operation on the operation input unit 210 or receiving the information from the external device via the communication interface unit 230. At this time, the environment information acquisition unit 252 desirably acquires the analysis information including information regarding the company, information regarding the customer, and information regarding the competitor. The environment information acquisition unit 252 desirably acquires the analysis information related to the product genre information or the like. In other words, the environment information acquisition unit 252 desirably acquires information regarding the company, the customer, and the competitor when viewed from an aspect related to a genre to be created.

The environment information acquisition unit 252 inputs the acquired analysis information and the product genre information into the trained model such as the large language model. As a result, the trained model performs 3C analysis using the received information or the like. As a result, the environment information acquisition unit 252 can acquire the business environment information such as the 3C information, as an output from the trained model. As described above, in addition to the analysis information, the product genre information or the like can be input to a training model. Therefore, the business environment information such as the 3C information output from the trained model can reflect the product genre information or the like.

The environment information acquisition unit 252 may acquire the business environment information such as the 3C information in an editable state. For example, the environment information acquisition unit 252 acquires the 3C information including an analysis result regarding each of “Customer (customer)”, “Competitor (competitor)”, and “Company (company)” from the trained model. Then, the environment information acquisition unit 252 displays the acquired 3C information on the screen display unit 220 or the like and receives edits from a user who has confirmed the display or the like. As an example, as illustrated in FIG. 4, the environment information acquisition unit 252 displays the 3C information, after adding an edit icon for each analysis result. As a result, the user who has confirmed the display can add, delete, change, or the like content for each analysis result, by operating the edit icon using the operation input unit 210 or the like.

The environment information acquisition unit 252 may receive execution of a hallucination check using the trained model or the like, for each analysis result included in the acquired 3C information. In this case, the environment information acquisition unit 252 may add a check icon or the like for instructing to execute the hallucination check, together with or instead of the edit icon, when performing the output as illustrated in FIG. 4.

The strategy information acquisition unit 253 functions as one of the framework information acquisition units. The strategy information acquisition unit 253 acquires the business strategy information such as the SWOT information. The strategy information acquisition unit 253 stores the acquired business strategy information in the storage unit 240.

For example, the strategy information acquisition unit 253 can acquire the business strategy information such as the SWOT information, for example, by receiving the operation on the operation input unit 210 or receiving the information from the external device via the communication interface unit 230.

The strategy information acquisition unit 253 may acquire the business strategy information such as the SWOT information, for example, by inputting the business environment information such as the 3C information into the trained model. FIG. 5 illustrates a more detailed processing example when the strategy information acquisition unit 253 acquires the business strategy information such as the SWOT information using the business environment information. Referring to FIG. 5, the strategy information acquisition unit 253 acquires the business environment information from the environment information acquisition unit 252. At this time, the strategy information acquisition unit 253 may acquire the business environment information edited by the user. The strategy information acquisition unit 253 can acquire additional information as necessary, for example, by receiving the operation on the operation input unit 210 or receiving the information from the external device via the communication interface unit 230. The strategy information acquisition unit 253 may acquire optional information such as data supplementing the business environment information or the like as the additional information.

The strategy information acquisition unit 253 inputs the acquired business environment information and the additional information into the trained model such as the large language model. As a result, the trained model performs SWOT analysis or the like using the received information. As a result, the strategy information acquisition unit 253 can acquire the business strategy information such as the SWOT information, as an output from the trained model. The strategy information acquisition unit 253 can input the business environment information reflecting the product genre information or the like into the trained model. As a result, the strategy information acquisition unit 253 can acquire the business strategy information reflecting the product genre information or the like. The strategy information acquisition unit 253 may acquire the business strategy information using a model same as that when the business environment information is acquired. The strategy information acquisition unit 253 may acquire the business strategy information using a model different from that when the business environment information is acquired.

As in a case of the business environment information, the strategy information acquisition unit 253 may acquire the business strategy information such as the SWOT information in an editable state. For example, the strategy information acquisition unit 253 acquires the SWOT information including an analysis result for each of “Strengths (strengths)”, “Weaknesses (weaknesses)”, “Opportunities (opportunities)”, and “Threats (threats)” from the trained model. Then, the strategy information acquisition unit 253 displays the acquired SWOT information on the screen display unit 220 or the like and receives the edits from the user who has confirmed the display or the like. As an example, as illustrated in FIG. 6, the strategy information acquisition unit 253 displays the SWOT information, after adding an edit icon for each analysis result. As a result, the user who has confirmed the display can add, delete, change, or the like content for each analysis result, by operating the edit icon using the operation input unit 210 or the like.

The strategy information acquisition unit 253 may receive execution of the hallucination check using the trained model, for each analysis result included in the acquired SWOT information. In this case, the strategy information acquisition unit 253 may add a check icon or the like for instructing to execute the hallucination check, together with or instead of the edit icon, when performing the output as illustrated in FIG. 6.

The value information acquisition unit 254 acquires the value information indicating values desired to be incorporated into the new product. The value information acquisition unit 254 may acquire the value information including one or a plurality of values. The value information acquisition unit 254 stores the acquired value information in the storage unit 240.

For example, the value information acquisition unit 254 can acquire the value information, for example, by receiving the operation on the operation input unit 210 or receiving the information from the external device via the communication interface unit 230. As an example, the value information acquisition unit 254 may acquire the value information, for example, by receiving selection from a predetermined value list. For example, the value information acquisition unit 254 displays the list of the values stored in advance, on the screen display unit 220 or the like. The value information acquisition unit 254 receives selection regarding the desired value from the displayed list, by receiving the operation on the operation input unit 210 by the user or the like. As a result, the value information acquisition unit 254 can acquire the value information including at least one value.

The value information acquisition unit 254 may acquire the value information, for example, by receiving the selection of the values using a product value network in which a product and a value are associated. FIG. 7 illustrates an example of the product value network that can be displayed on the screen display unit 220 or the like by the value information acquisition unit 254. For example, in a case of FIG. 7, the product value network includes a certain product and a value associated with the certain product. In addition, the product value network can include a second product that is a product having a value common to the value related to the certain product, and a value associated with the second product. In other words, in a case of FIG. 7, the product value network includes a value related to a beer A, and a value related to a chocolate A, a beer B, an instant noodle A, or the like having a common value. In this way, it is desirable for the product value network to include the values related to the plurality of types of products. The product value network includes the values related to the plurality of types of products in such a way that the user can select the value from a more cross-sectional viewpoint.

The product value network may narrow a genre of a product to be displayed by the selection by the user, using the operation input unit 210 or the like. The product value network may be able to narrow a type of a value to be displayed by the selection by the user, using the operation input unit 210 or the like. For example, the product value network may display only some values by the selection by the user, such as displaying only a value common to various products or displaying only a value seen in a small number of products. The product value network can enlarge or reduce the display by the selection by the user.

The value information acquisition unit 254 may receive selection of a product of which a value is desired to be analyzed from the user, by the operation on the operation input unit 210 or the like. In this case, the value information acquisition unit 254 can display a product value network centered on the products selected by the user. For example, as illustrated in FIG. 8, the value information acquisition unit 254 may receive the selection of the product of which the value is desired to be analyzed from the user, after displaying products to be candidates on the screen display unit 220 or the like. The value information acquisition unit 254 may be able to narrow the products to be the candidates by the selection from the user. For example, in a case illustrated in FIG. 8, by selecting an option in a drop-down menu by the operation on the operation input unit 210 or the like, the user can narrow the products to be the candidates.

A value network, a list of the products to be the candidates, or the like may be prepared in advance using any means. For example, the value network, the list of the products to be the candidates, or the like may be stored in the storage unit 240 or the like.

The concept information generation unit 255 generates the concept information indicating a consideration result of the new product, in response to an input of the information acquired by each processing unit described above. The concept information generation unit 255 stores the generated concept information in the storage unit 240.

FIG. 9 illustrates a more detailed processing example when the concept information generation unit 255 generates the concept information. Referring to FIG. 9, the concept information generation unit 255 acquires the business environment information, the business strategy information, and the value information. The concept information generation unit 255 inputs the business environment information, the business strategy information, and the value information into the trained model such as the large language model. As a result, the trained model generates the concept information by performing analysis using the received information. As a result, the concept information generation unit 255 can acquire the concept information, as the output from the trained model. The concept information generation unit 255 may input the product genre information or the like into the trained model, in addition to the information described above. In other words, the product genre information may be used when the framework information such as the business environment information or the business strategy information is generated or may be used when the concept information is generated, together with or instead of the above. The concept information generation unit 255 can use a trained model or the like adjusted for concept information generation. The concept information generation unit 255 may use the trained model common to the environment information acquisition unit 252 or the like described above.

For example, the trained model generates a concept sheet indicating a concept of a new product for a combination, by combining some of the plurality of values included in the value information. The trained model generates a concept sheet related to each combination, by changing the combination of the values. For example, by executing the above processing, the trained model can generate the concept information including the plurality of concept sheets.

FIG. 10 illustrates an example of the concept information generated by the concept information generation unit 255. In a case of the example in FIG. 10, the concept information includes five concept sheets from “proposal 1” to “proposal 5”. Each concept sheet includes items such as “image”, “concept”, “target”, “preference”, “background”, “values”, or “movement of competitor company”. Here, the item of “image” can include image data generated by inputting a sentence in the item such as “concept” into image generative Artificial Intelligence (AI) or the like. In addition to “concept”, at least a part of a sentence among the optional items such as “preference” or “values” may be input into the image generative AI. The item of “concept” can include the information indicating the consideration result regarding the new product, such as a concept to be reflected on the new product or information indicating the concept of the new product. The item of “values” can include information indicating a value used when a related concept sheet is generated, among the plurality of values included in the value information. In addition, each item may include information related to each item.

The concept information generation unit 255 may acquire the concept information in an editable state. For example, the concept information generation unit 255 acquires the concept information from the trained model. Then, the concept information generation unit 255 displays the acquired concept information on the screen display unit 220 or the like and receives the edits from the user who has confirmed the display or the like. As an example, as illustrated in FIG. 10, the concept information generation unit 255 displays the concept information, after adding the edit icon to each item. As a result, the user who has confirmed the display can, for example, add, delete, or change content for each item, by operating the edit icon using the operation input unit 210 or the like. In a case where the item, such as the item of “concept”, used when an image in the “image” is generated is changed, the concept information generation unit 255 may regenerate the image in the “image” by inputting the changed information into the image generative AI.

FIG. 10 illustrates merely an example of the concept sheet or the concept information. The configurations of the concept sheet and the concept information are not limited to those in a case illustrated in FIG. 10. For example, the concept sheet may include some of the items described above. The concept sheet may include an item other than those described above.

The output unit 256 outputs the concept information or the like illustrated in FIG. 10. The output unit 256 may transmit the concept information to the external device or the like via the communication interface unit 230. For example, the output unit 256 may output the concept information or the like as an electronic document having any format.

The output unit 256 may output at least one of the business environment information, the business strategy information, the value information, or the like, in addition to the concept information.

The above is the configuration example of the generation device 200. Next, referring to FIG. 11, an operation example of the generation device 200 will be described.

FIG. 11 is a flowchart illustrating the operation example of the generation device 200. Referring to FIG. 11, the genre information acquisition unit 251 acquires the product genre information (step S101).

The environment information acquisition unit 252 acquires the business environment information such as the 3C information (step S102). For example, the environment information acquisition unit 252 can acquire the business environment information, for example, by inputting the analysis information into the trained model.

The strategy information acquisition unit 253 acquires the business strategy information such as the SWOT information (step S103). For example, the strategy information acquisition unit 253 can acquire the business strategy information, for example, by inputting the business environment information such as the 3C information into the trained model.

The value information acquisition unit 254 acquires the value information (step S104). The value information acquisition unit 254 can acquire the value information, for example, by receiving the operation on the operation input unit 210 or receiving the information from the external device via the communication interface unit 230. The value information acquisition unit 254 may acquire the value information using the product value network or the like.

The concept information generation unit 255 inputs the business environment information, the business strategy information, and the value information into the trained model such as the large language model. The concept information generation unit 255 acquires the concept information, as the output from the trained model. As described above, the concept information generation unit 255 generates the concept information from the business environment information, the business strategy information, and the value information, by using the trained model (step S105).

The output unit 256 outputs the concept information or the like (step S106). The output unit 256 may output at least some of the business environment information, the business strategy information, the value information, or the like, in addition to the concept information.

The above is the operation example of the generation device 200. The operation of the generation device 200 is not limited to a case illustrated in FIG. 11. For example, the processing from step S101 to step S104 may be executed in an order different from the order illustrated in FIG. 11.

In this way, the generation device 200 includes the genre information acquisition unit 251, the environment information acquisition unit 252, the strategy information acquisition unit 253, the value information acquisition unit 254, and the concept information generation unit 255. With such a configuration, the concept information generation unit 255 can generate the concept information, according to the product genre information, the business environment information, the business strategy information, and the value information. As a result, the user or the like who has confirmed the generated concept information can easily confirm the concept of the new product. As a result, the generation device 200 can support concept drafting regarding the new product that is the consideration subject.

According to the configuration described above, the environment information acquisition unit 252 can acquire the business environment information such as the 3C information by inputting the analysis information into the trained model. The strategy information acquisition unit 253 can acquire the business strategy information such as the SWOT information by inputting the business environment information into the trained model. It is often difficult to perform logical analysis using the collected analysis information. However, according to the configuration described above, the generation device 200 can easily perform logical analysis using the collected analysis information or the like.

The value information acquisition unit 254 can acquire the value information using the product value network including the values related to the plurality of types of products. According to such a configuration, it is possible to select the value or the like desired to be incorporated into the concept from among the values related to the plurality of products across the genres. As a result, more flexible value information across genres can be acquired.

### Second Example Embodiment

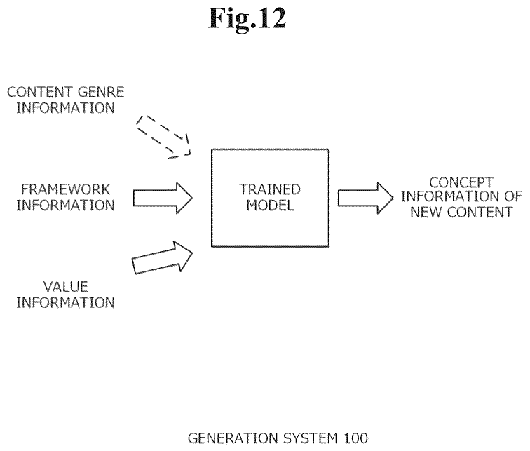

Next, a modification of the generation system 100 will be described with reference to FIG. 12. For example, in the first example embodiment, a case has been described in which the consideration subject is the new product. However, as described above, the consideration subject may be new content such as a new program or may be any other subject.

FIG. 12 illustrates an outline of the generation system 100 in a case where the consideration subject is the new content. Referring to FIG. 12, the generation system 100 acquires content genre information, any framework information related to the consideration subject, and value information. Then, the generation system 100 generates concept information by inputting each piece of the acquired information into a trained model. In this way, in a case where the consideration subject is different from the new product, genre information is according to the consideration subject. The framework information can be information according to the consideration subject. The generation system 100 can generate the concept information as in a case described above, by acquiring and inputting the information according to the consideration subject described above into the trained model.

As described above, even in a case where the consideration subject is other than the new product, by acquiring the information related to the consideration subject, the generation system 100 can generate the concept information by executing the processing similar to that in the first example embodiment.

### Third Example Embodiment

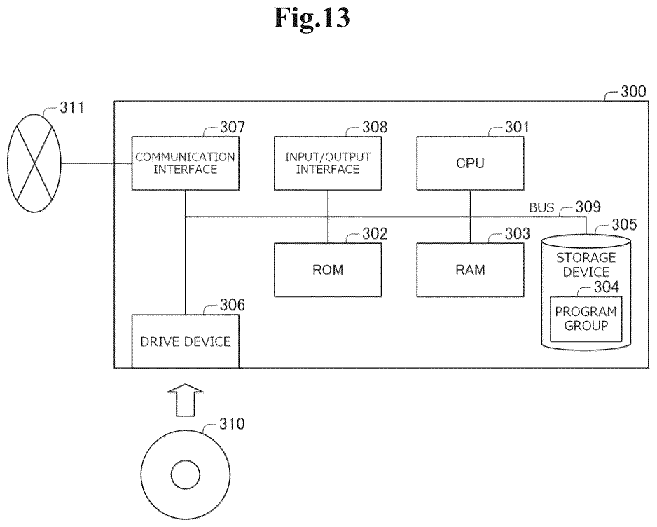

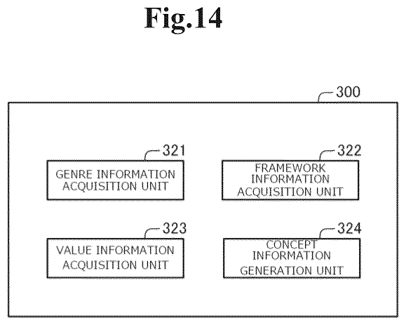

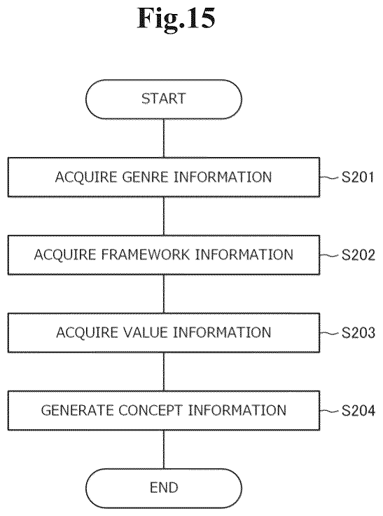

Next, an information processing apparatus 300 that is a modification of the generation device 200 will be described with reference to FIGS. 13 to 15. FIG. 13 is a diagram illustrating a hardware configuration example of the information processing apparatus 300. FIG. 14 is a block diagram illustrating a configuration example of the information processing apparatus 300. FIG. 15 is a flowchart illustrating an operation example of the information processing apparatus 300.

The information processing apparatus 300 is an apparatus that generates concept information indicating a consideration result of a consideration subject according to genre information, framework information, and value information. FIG. 13 illustrates a hardware configuration example of the information processing apparatus 300. Referring to FIG. 13, the information processing apparatus 300 has the following hardware configuration, as an example.
A Central Processing Unit (CPU) 301 (arithmetic device)
A Read Only Memory (ROM) 302 (storage device)
A Random Access Memory (RAM) 303 (storage device)
A program group 304 loaded into the RAM 303
A storage device 305 storing the program group 304
A drive device 306 that reads and writes a recording medium 310 outside the
A communication interface 307 connected to a communication network 311 outside the information processing apparatus
An input/output interface 308 for inputting/outputting data
A bus 309 for connecting each component

The information processing apparatus 300 can achieve functions as a genre information acquisition unit 321, a framework information acquisition unit 322, a value information acquisition unit 323, and a concept information generation unit 324 illustrated in FIG. 14, by the CPU 301 acquiring the program group 304 and executing the

program group 304. The program group 304 is stored, for example, in the storage device 305 or the ROM 302, and the CPU 301 loads and executes the program group 304 on the

RAM 303 or the like as necessary. The program group 304 may be supplied to the CPU 301 via the communication network 311, or the drive device 306 may read the program stored in the recording medium 310 in advance and supply the program to the CPU 301.

FIG. 13 illustrates a hardware configuration example of the information processing apparatus 300. The hardware configuration of the information processing apparatus 300 is not limited to the case described above. For example, the information processing apparatus 300 may have a part of the above configuration such as a configuration that does not include the drive device 306. The CPU 301 may be the GPU described in the first example embodiment or the like.

The genre information acquisition unit 321 acquires the genre information indicating a genre to which the consideration subject belongs. For example, the genre information acquisition unit 321 may acquire the genre information by receiving an operation from a user.

The framework information acquisition unit 322 acquires the framework information related to the consideration subject. The framework information acquisition unit 322 may acquire the framework information by using any means, such as receiving the operation from the user or inputting any analysis information into a trained model. The framework information acquisition unit 322 may acquire the framework information by inputting the genre information or the like, in addition to the analysis information, into the trained model.

The value information acquisition unit 323 acquires the value information indicating a value desired to be incorporated into the consideration subject. The value information acquisition unit 323 may acquire the value information, for example, by receiving the operation from the user.

The concept information generation unit 324 generates the concept information indicating the consideration result of the consideration subject according to the genre information, the framework information, and the value information. As an example, the concept information generation unit 324 can generate the concept information by inputting the genre information, the framework information, and the value information into the trained model. The genre information may be input into the trained model via the framework information, by being used when the framework information is acquired.

The above is the configuration example of the information processing apparatus 300. Next, the operation example of the information processing apparatus 300 will be described with reference to FIG. 15.

FIG. 15 is a flowchart illustrating the operation example of the information processing apparatus 300. Referring to FIG. 15, the genre information acquisition unit 321 acquires the genre information indicating the genre to which the consideration subject belongs (step S201). The framework information acquisition unit 322 acquires the framework information related to the consideration subject (step S202). The value information acquisition unit 323 acquires the value information indicating the value desired to be incorporated into the consideration subject (step S203). An order of the processing from step S201 to step S203 may be appropriately changed.

The concept information generation unit 324 generates the concept information indicating the consideration result of the consideration subject according to the genre information, the framework information, and the value information (step S204). As an example, the concept information generation unit 324 can generate the concept information by inputting the genre information, the framework information, and the value information into the trained model.

In this way, the information processing apparatus 300 includes the genre information acquisition unit 321, the framework information acquisition unit 322, the value information acquisition unit 323, and the concept information generation unit 324. With such a configuration, the concept information generation unit 324 can generate the concept information indicating the consideration result of the consideration subject according to the genre information, the framework information, and the value information. As a result, the user or the like who has confirmed the generated concept information can easily confirm concept of a new product. As a result, the information processing apparatus 300 can support concept drafting regarding the new product that is the consideration subject.

The information processing apparatus 300 described above can be achieved by incorporating a predetermined program into the information processing apparatus 300. Specifically, a program that is another mode of the present disclosure is a program for causing an information processing apparatus to achieve processing for acquiring genre information indicating a genre to which a consideration subject belongs, acquiring framework information related to the consideration subject, acquiring value information indicating a value desired to be incorporated into the consideration subject, and generating concept information indicating a consideration result of the consideration subject according to the genre information, the framework information, and the value information.

An information processing method executed by the information processing apparatus 300 or the like is a method, by an information processing apparatus, for acquiring genre information indicating a genre to which a consideration subject belongs, acquiring framework information related to the consideration subject, acquiring value information indicating a value desired to be incorporated into the consideration subject, and generating concept information indicating a consideration result of the consideration subject according to the genre information, the framework information, and the value information.

Since the program, the computer readable recording medium recording the program, the information processing method, or the like having the above configuration can achieve workings and effects similar to those of the information processing apparatus 300, the object of the present disclosure can be achieved.

### Supplementary Note

Some or all of the above example embodiments may be described as in the following Supplementary Notes. Hereinafter, an outline of the information processing apparatus or the like according to the present disclosure will be described. However, the present disclosure is not limited to the following configuration.

### Supplementary Note 1

An information processing apparatus including:
a genre information acquisition unit configured to acquire genre information indicating a genre to which a consideration subject belongs;
a framework information acquisition unit configured to acquire framework information related to the consideration subject;
a value information acquisition unit configured to acquire value information indicating a value desired to be incorporated into the consideration subject; and
a concept information generation unit configured to generate concept information indicating a consideration result of the consideration subject according to the genre information, the framework information, and the value information.

### Supplementary Note 2

The information processing apparatus according to supplementary note 1, in which
the concept information generation unit generates the concept information including image data generated according to a concept, together with information indicating the concept for the consideration subject.

### Supplementary Note 3

The information processing apparatus according to supplementary note 1 or 2, in which
the concept information generation unit generates the concept information including information indicating a value used when the concept information is generated, among values included in the value information.

### Supplementary Note 4

The information processing apparatus according to any one of supplementary notes 1 to 3, in which
the framework information acquisition unit acquires at least one of business environment information that is information according to a business environment and business strategy information that is information according to a business strategy, as the framework information, and
the concept information generation unit generates the concept information, according to the genre information, at least one of the business environment information and the business strategy information, and the value information.

### Supplementary Note 5

The information processing apparatus according to supplementary note 4, in which
the framework information acquisition unit acquires the business environment information related to the consideration subject, in an editable state, in response to an input of analysis information according to the consideration subject.

### Supplementary Note 6

The information processing apparatus according to supplementary note 5, in which
the framework information acquisition unit acquires the business strategy information in an editable state according to the acquired business environment information.

### Supplementary Note 7

The information processing apparatus according to any one of supplementary notes 1 to 6, in which
the value information acquisition unit acquires the value information by receiving selection of a value using a product value network in which a product and a value are associated.

### Supplementary Note 8

The information processing apparatus according to supplementary note 7, in which
the value information acquisition unit displays the product value network in a state where a value to be displayed is narrowed and receives the selection of the value using the product value network.

### Supplementary Note 9

An information processing method executed by an information processing apparatus, the method including:
acquiring genre information indicating a genre to which a consideration subject belongs;
acquiring framework information related to the consideration subject;
acquiring value information indicating a value desired to be incorporated into the consideration subject; and
generating concept information indicating a consideration result of the consideration subject according to the genre information, the framework information, and the value information.

### Supplementary Note 10

A program for causing an information processing apparatus to achieve processing for:
acquiring genre information indicating a genre to which a consideration subject belongs;
acquiring framework information related to the consideration subject;
acquiring value information indicating a value desired to be incorporated into the consideration subject; and
generating concept information indicating a consideration result of the consideration subject according to the genre information, the framework information, and the value information.

Some or all of the configurations described in Supplementary Notes 2 to 8 dependent on the information processing apparatus described in Supplementary Note 1 can also be dependent on the information processing method described in Supplementary Note 9 and the program described in Supplementary Note 10 by the same dependency relationship as Supplementary Notes 2 to 8. Some or all of the configurations described as the Supplementary Notes can be similarly dependent on not only the Supplementary Notes 9 and 10, but also various pieces of hardware and software, various types of recording means for recording software, methods, programs, or systems without departing from the above-described example embodiments.

In addition, the program described in each example embodiment described above and supplementary notes can be stored using various types of non-transitory computer-readable media and supplied to the computer. The non-transitory computer readable media include various types of tangible storage media. Examples of the non-transitory computer readable medium include a magnetic recording medium (for example, a flexible disk, a magnetic tape, or a hard disk drive), an optical magnetic recording medium (for example, a magneto-optical disk), a compact disc-Read Only Memory (CD-ROM), a CD-R, a CD-R/W, and a semiconductor memory (for example, a mask ROM, a Programmable ROM (PROM), an Erasable PROM (EPROM), a flash ROM, or a Random Access Memory (RAM)). The program may be supplied to the computer by various types of transitory computer readable media (transitory computer readable medium). Examples of the transitory computer readable media include electrical signals, optical signals, and electromagnetic waves. The transitory computer readable media can supply the programs to the computer via a wired communication path such as an electric wire and an optical fiber or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

1. An information processing apparatus comprising:
at least one memory configured to store processing instructions; and
at least one processor configured to execute the processing instructions to:
acquire genre information indicating a genre to which a consideration subject belongs,
acquire framework information related to the consideration subject,
acquire value information indicating a value desired to be incorporated into the consideration subject, and
generate concept information indicating a consideration result of the consideration subject according to the genre information, the framework information, and the value information.

2. The information processing apparatus according to claim 1, wherein at least one processor is configured to execute the processing instructions to:
generate the concept information including image data generated according to a concept, together with information indicating the concept for the consideration subject.

3. The information processing apparatus according to claim 1, wherein at least one processor is configured to execute the processing instructions to:
generate the concept information that includes information indicating a value used when the concept information is generated, among values included in the value information.

4. The information processing apparatus according to claim 1, wherein at least one processor is configured to execute the processing instructions to:
acquire at least one of business environment information that is information according to a business environment and business strategy information that is information according to a business strategy, as the framework information; and
generate the concept information, according to the genre information, at least one of the business environment information and the business strategy information, and the value information.

5. The information processing apparatus according to claim 4, wherein at least one processor is configured to execute the processing instructions to:
acquire the business environment information related to the consideration subject, in an editable state, in response to an input of analysis information according to the consideration subject.

6. The information processing apparatus according to claim 5, wherein at least one processor is configured to execute the processing instructions to:
acquire the business strategy information in an editable state according to the acquired business environment information.

7. The information processing apparatus according to claim 1, wherein at least one processor is configured to execute the processing instructions to:
acquire the value information by receiving selection of a value using a product value network in which a product and a value are associated.

8. The information processing apparatus according to claim 7, wherein at least one processor is configured to execute the processing instructions to:
display the product value network in a state where a value to be displayed is narrowed, and receive the selection of the value using the displayed product value network.

9. The information processing apparatus according to claim 1, wherein the generating the concept information comprises inputting at least the framework information and the value information into a pretrained machine learning model to obtain the concept information as an output from the model.

10. The information processing apparatus according to claim 1, wherein the processor is further configured to output the concept information to a display, thereby providing materials to a user to support user's decision making regarding the concept for the consideration subject.

11. An information processing method executed by an information processing apparatus, the method comprising:
acquiring genre information indicating a genre to which a consideration subject belongs;
acquiring framework information related to the consideration subject;
acquiring value information indicating a value desired to be incorporated into the consideration subject; and
generating concept information indicating a consideration result of the consideration subject according to the genre information, the framework information, and the value information.

12. A computer-readable recording medium recording a program for causing an information processing apparatus to achieve processing for:
acquiring genre information indicating a genre to which a consideration subject belongs;
acquiring framework information related to the consideration subject;
acquiring value information indicating a value desired to be incorporated into the consideration subject; and
generating concept information indicating a consideration result of the consideration subject according to the genre information, the framework information, and the value information.
